(19) United States
(12) Patent Application Publication
(10) Pub. No.: US 2026/0219517 A1
(43) Pub. Date: Jul. 30, 2026

(54) CONTACT LENS WITH A GRADIENT OPTICAL SYSTEM

(71) Applicant: XPANCEO RESEARCH ON NATURAL SCIENCE L.L.C. S.O.C., Dubai (AE)

(72) Inventors: Aleksey Vladimirovich Arsenin, Moscow (RU); Vyacheslav Sergeevich Brunov, Moscow (RU); Valentin Sergeevich Volkov, Dolgoprudnyy (RU); Georgii Alekseevich Ermolaev, Dolgoprudnyy (RU); Alexander Vyacheslavovich Syuy, Moscow (RU)

(21) Appl. No.: 19/158,213

(22) PCT Filed: Dec. 18, 2023
(86) PCT No.: PCT/RU2023/050296

§ 371 Date: Aug. 20, 2025

(30) Foreign Application Priority Data
Feb. 27, 2023 (RU) 2023104394

(51) Int. Cl. G02C 7/04

(52) U.S. Cl. CPC G02C 7/049

(57) ABSTRACT

The invention relates to wearable optics and specifically to the contact lenses comprising an integrated information display device in the form of a microdisplay with a gradient lens, and can be used to form augmented, virtual, or extended reality (AR/VR/XR). The claimed contact lens comprises a flat display with the maximum dimension d, whose screen is located on the contact lens axis of symmetry and directed towards the user's eye, a power and control unit, and a collimating optical system located between the display and the eye. Said collimating optical system is implemented as a single converging lens that has the diameter D and a radial refractive index gradient and whose optical axis coincides with said axis of symmetry of the contact lens. The technical effect consists in reducing the contact lens overall dimensions while keeping the clarity from the perceived image on the display screen.

### TECHNICAL FIELD

The invention relates to wearable optics and specifically to the contact lenses comprising an integrated information display device in the form of a microdisplay with a gradient lens, and can be used to form augmented, virtual, or extended reality (AR/VR/XR).

### BACKGROUND ART

The engineering problem of forming a clear image from a display located at a small distance (less than 8 cm) away from a user's eye, especially in a contact lens, is not simple. The complexity results from the necessity to simultaneously meet the conditions of forming a clear image on the retina and keeping the overall size compact (not exceeding several mm) to enable comfortable use.

The problem of forming the image can be solved using a light field display (see ‘Lightweight electrowetting display on ultra-thin glass substrate’, Han You, Andrew Steckl, Journal of the Society for Information Display, 1 May 2013). The light field displays are configured to generate light wavefronts that imitate (mimic) the wavefronts of the objects located at a distance from each other. With such displays, there is no need for the eye to focus (which is impossible) on the display pixels. The pixels of the light field display are represented by microlenses assembled as an array. Under each microlens, a small pixel display is disposed that emits a partial image of the called (virtual) scene, and each partial image corresponds to a view of the object that is to be displayed at the corresponding angle. Hence, the light field displays suffer from a problem consisting in that each pixel in fact consists of a small display, which, in its turn, limits the size and resolution of the microlens pixels. Furthermore, the light field displays must display a plurality of different sub-images for the small microlens displays, which results in big computational costs.

The prior art discloses an information displaying method consisting in projecting an image or a series of images onto a retina by embedding an imaging lens around a contact lens perimeter so that to project the image inward towards the center of the contact lens, after which the projected light is redirected onto the retina (see patent U.S. Pat. No. 11,061,232B2, cl. G02C 7/04, published 13 Jul. 2021). The prior art solution has a low-level power consumption and can be built (integrated) into a flexible material of a contact lens. Disadvantages of the prior art method and device consist in the complexity to manufacture the curved composite matrix of lenses with a refractive index gradient from an optical fiber, as well as in labor-consuming adjustment of the system of prisms at the fiber input and at the fiber output to transmit the image onto the eye retina.

The prior art discloses a wearable optical device comprising a curved display that is formed by a plurality of optical elements represented by a central emitter with the optics collimating the light along the optical axis (see application WO2019101994A1, cl. G02B 27/01, published 31 May 2019). In one of the embodiments, the device is represented by a contact lens with integrated optical elements in the form of light emitting diodes (LEDs) each having a GRIN (gradient-index) lens—a converging lens with a radial refractive index gradient—located in front of it. The prior art device makes it possible to form for the user distinguishable clear images with the possibility to selectively turn on and off individual optical elements. Disadvantages of the method consist in the complexity to manufacture the curved screen (forming a lot of aberrations), labor-consuming configuration of the collimating elements, as well as the complexity to form a system to selectively activate the emitters, and a limited field of view (8° to 40°). Furthermore, when only a part of the side emitters needed to project the image onto the retina are activated, the produced image has the angular resolution 10, 100 or 400 times lower in comparison with an image that is projected when all of the side emitters are activated in the range of peripheral vision and/or within the field of view. Due to the low refractive index gradient (up to 0.1) in the used GRIN lenses, there is a need to increase their relative linear dimension along the light emitting diode optical axis. In this case, to retain the possibility to place such integrated structure inside the lens, the light emitting diodes have to be spaced relative to each other, which imposes serious limitations upon the maximum resolution of the projected image.

The gradient lens (GRIN lens) is an optical element in which the light propagation is provided by change of the refractive index inside the lens itself rather than by the radius of curvature as in the conventional lenses. The gradient lenses can have various shapes and refractive index profile. Hereinafter, mostly the cylindrical GRIN lenses with a radially distributed refractive index and flat ends will be discussed.

For a lens to be converging, the refractive index in the GRIN lens central part must be higher than on the edges in the peripheral part. The light propagating through such GRIN lens undergoes the periods of focusing inside the lens itself. While passing along the length P that is equal to one full period, the image at one of the GRIN lens ends is transmitted to the other end uninverted. If a point light source is located at one end of a P/4 long GRIN lens, such GRIN lens, once the light has passed through, collimates it at the output end. The higher the induced radial refractive index gradient Δn, the shorter the length of the total period P for the same radial dimension of the GRIN lens.

The relatively new possibility to produce converging lenses with high refractive index gradient (0.3 to 3) that opened owing to the use of nanoparticles (see application US20220155496, cl. G02B 1/04, published 19 May 2022) makes it possible to significantly reduce the gradient lens dimensions and realize formerly unfeasible ultra-compact structures with such collimating optical system.

The closest, in terms of technical substance, to the disclosed invention is a contact lens comprising a flat display with a screen located on the contact lens axis of symmetry and directed towards the user's eye, a power and control unit, and a telescopic collimating optical system located between the display and the eye (see patent U.S. Pat. No. 10,353,205B2, cl. G02C 7/04, published 16 Jul. 2019). Disadvantages of the prior art device are relatively large thickness (over 4 mm), making it rather in-convenient to use, and the complexity to manufacture and adjust the suggested collimating optical system.

The technical problem is to eliminate the above disadvantages and to create a device capable of displaying distinguishable clear microdisplay images on the user's eye retina with a wide field of view.

### SUMMARY OF INVENTION

The technical effect consists in reducing the contact lens overall dimensions while keeping the clarity of the perceived image on the display screen. The set problem has been solved and the technical effect has been achieved by that inside the contact lens containing a flat display with the maximum dimension d, whose screen is located on the contact lens axis of symmetry and directed towards the user's eye, a power and control unit, and a collimating optical system located between the display and the eye, said collimating optical system is implemented as a single converging lens that has the diameter D and a radial refractive index gradient and whose optical axis coincides with said axis of symmetry of the contact lens. The refractive index difference Δn on the axis and in the peripheral part of the converging lens preferably comprises not less than 0.2. The display and the converging lens are preferably made so that 1.2≤D/d≤4, more precisely: 1.4≤D/d≤1.7. The converging lens is preferably made so that its longitudinal dimension L along the optical axis correlates with said diameter D as 0.7≤D/L≤1.7, more precisely: 1.4≤D/L≤1.6. Said converging lens is preferably a cylindrical GRIN lens with a parabolic radial distribution of the refractive index. The apparent angular dimension of the display preferably comprises not more than 50% of the field of view. The display can be attached directly to the converging lens front surface or a layer of material transparent in the visible range of the spectrum can be placed between them. Alternatively, the contact lens can be provided with a hollow chamber on whose opposite walls the converging lens and the display are attached with a gap between them. The display is preferably a light emitting diode based display.

### BRIEF DESCRIPTION OF DRAWINGS

FIG. 1 is a cross-sectional view of the disclosed device installed on a user's eye;

FIG. 2 is a general layout of the components in the device with a square display, front view;

FIG. 3 the same as FIG. 2, with a round display;

FIG. 4 is a diagram showing the display installation directly on the converging lens;

FIG. 5 the same as FIG. 4, with indicated dimensions of the components;

FIG. 6 is a diagram showing the display installation on a converging lens with a polymer layer in between;

FIG. 7 is a diagram showing the display and converging lens installation on the walls of a hollow chamber.

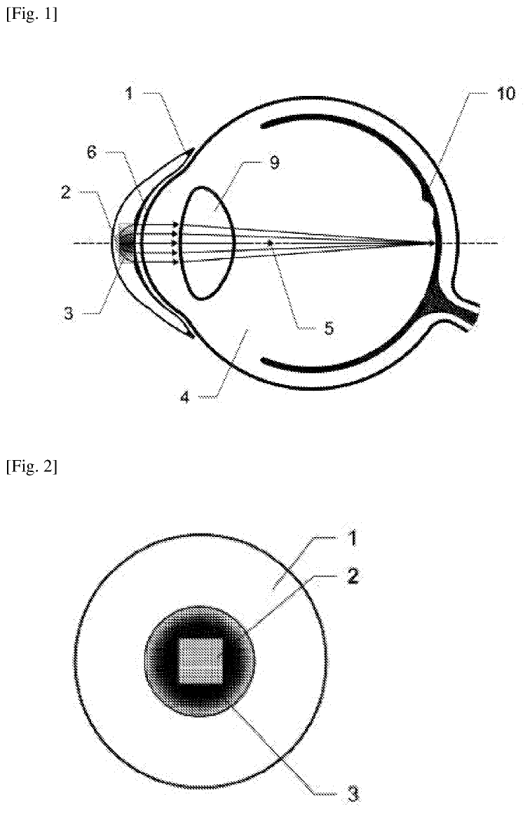

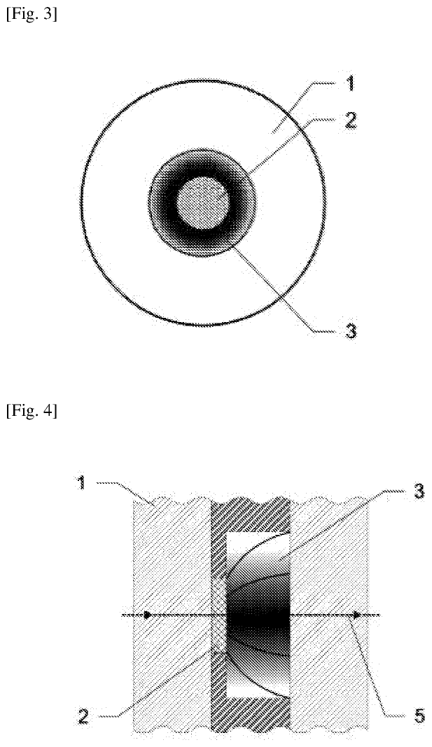

### DESCRIPTION OF EMBODIMENTS

The disclosed device comprises a contact lens 1, wherein the lens body contains an integrated projector based on the display 2, a power and control unit (not shown in the drawings), and a collimating optical system in the form of the converging lens 3 that has a radial refractive index gradient (GRIN lens) and is located between the display 2 and the eye 4. The contact lens 1 can be a scleral lens made of glass or hard transparent plastic, or a flexible lens made of a biocompatible polymeric material.

The display 2 is flat and based on a light emitting diode matrix (LED, microLED, OLED, etc.), with a screen directed towards the user's eye pupil 4. The display 2 can have the size from 50×50 to 500×500 μm, preferably 100×100 μm, with the pixel size up to 1 μm. Alternatively, the display can have any other shape, such as rectangular or round with the diameter of 50, 100, 500 μm and with the pixels arranged in a honeycomb pattern (hexagons). As used herein, the maximum dimension d refers to the maximum linear dimension: the diagonal of a square or rectangle, the diameter of a circle, the distance between the opposite vertexes of a hexagon, etc. The power and control unit can comprise a built-in rechargeable battery, a metal induction coil, a photoelectronic device, etc.

The display 2 and the converging lens 3 are located on the axis of symmetry 5 of the contact lens 1, which makes it possible to significantly simplify the whole structure and its adjustment, as well as to minimize image distortions in the projection system. Herewith, making the display 2 flat makes it easier to manufacture and install on the front surface of the converging GRIN lens 3, as well as minimizes possible aberrations. To enable realization of the augmented or extended reality features, the apparent angular dimension of the display 2 must not exceed 50% of the field of view.

The converging GRIN lens 3 is preferably composed of radially arranged layers having different concentrations of highly refractive particles, so that the difference between the refractive indices Δn on the axis and in the peripheral part of the converging lens 3 is not less than 0.2: Δn≥0.2. In this case, the overall dimensions of the converging GRIN lens 3 can be chosen so that to fit it within the body of the contact lens 1: for the display 2 having the dimensions of 500×500 μm (diagonal 0.7 mm), the diameter D of the converging GRIN lens 3 will be approximately 1 mm, with the thickness L (for Δn=2) being approximately 0.8 mm.

Said converging lens 3 is preferably a cylindrical GRIN lens with a parabolic radial distribution of the refractive index, i.e. meets the condition:

$${n}^{2} ( R ) = {n}_{0}^{2} ( 1 - {g}^{2} {R}^{2} ) \qquad [ Math . 1 ]$$

where R is the converging GRIN lens 3 radius along which the change of the refractive index occurs,
n₀ is the refractive index in the central part of the converging GRIN lens 3,
n(R) is the refractive index in point R,
g is the force constant of the converging GRIN lens 3.

In this case, the force coefficient g is defined as

$$g = \frac{1}{R} \sqrt{2 \frac{Δ n}{{n}_{0}}} \qquad [ Math . 2 ]$$

where

$$Δ n = {n}_{0} - {n}_{R} \qquad [ Math . 3 ]$$

(n_{R} is the refractive index in the lens periphery), on one hand, and

$$g = 2 π / P \qquad [ Math . 4 ]$$

on the other hand, where P is the length of the full period (Pitch).

An ideal converging lens with a smooth parabolic radial distribution of the refractive index does not introduce any wavefront distortions while transmitting an image, but its stepwise analogue (in case the converging GRIN lens 3 is composed of the layers with different concentrations of highly refractive nanoparticles) can provide sufficiently clear transmission as well (in this case, it is preferable to use at least 20 layers).

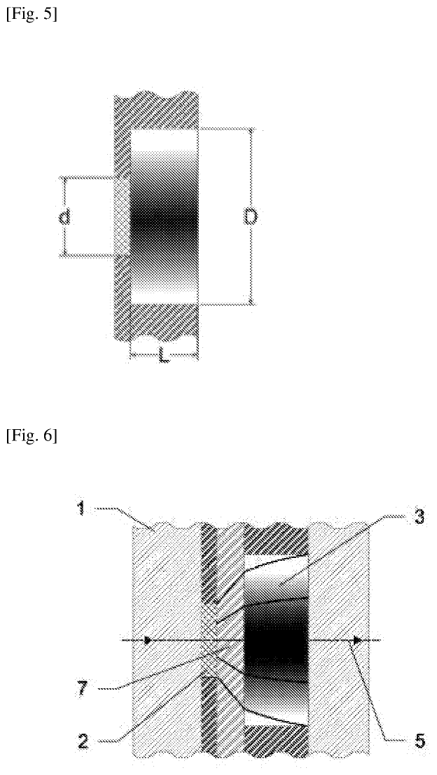

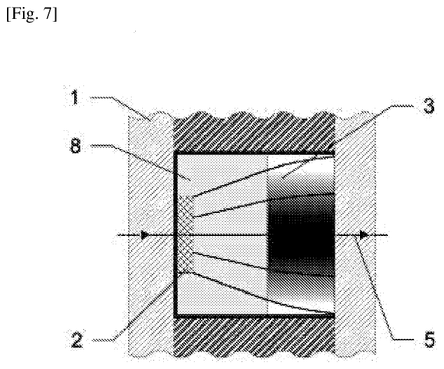

In order to collimate the rays coming from the image source represented by the display 2, the distance between said display 2 and the converging GRIN lens 3 along the optical axis 5 must range from 0 to 300 μm. In this case, the following lenses can be used: a P/4 long converging GRIN lens with the focus being at the front surface of the end [FIG. 4]-[FIG. 5], or a converging GRIN lens with the length less than P/4 (0.25 P), for example, 0.15 P-0.24 P, preferably 0.22 P, having the focus near, but not immediately adjacent to, the front surface of the inlet end [FIG. 6]-[FIG. 7].

FIG. 4 shows an embodiment of the contact lens 1 with the projector based on a 0.25 P long GRIN lens. In this case, the whole projection optical system comprises the converging GRIN lens 3 having the display 2 installed immediately adjacent directly on its front surface. The space between the display 2 and the converging GRIN lens 3 is absent or negligible as compared with the lens 3 overall dimensions (for example, a several microns thick optical adhesive).

The advantage of having no gap between the converging GRIN lens 3 and the display 2 consists in simplified optical adjustment (adjustment of the optical components relative position) and provision of the minimum overall dimensions of the projector along the optical axis 5 (since the rays from the display 2 diverge in a wide angle), while the disadvantage consists in that it is difficult to produce the lens of 0.25 P length in accordance with the manufacturing accuracy.

This whole structure can be incorporated into the contact lens 1 using the following method: in the center on the primary layer of polymer (the closest to the cornea 6) of the contact lens 1, a projector in the form of the converging GRIN lens 3 with the glued-on display 2 is installed, on the periphery, all the required electronics are installed (inductance coil, rechargeable battery, power and display control conductors, etc.), after which the periphery is encapsulated in a polymer and polymerized to fix the projector body, and then a finishing layer of polymer (farthermost from the cornea 6) is applied and polymerized as well.

FIG. 6 shows an embodiment of the contact lens 1 with a projector based on a 0.15-0.24 P long GRIN lens having the gap 7 between the display 2 and the converging GRIN lens 3, wherein the gap is formed by a material transparent in the visible range of the spectrum, such as a polymer. This structure is produced using the following method: in the center on the primary layer of polymer (the closest to the cornea 6) of the contact lens 1, the converging GRIN lens 3 is installed, the periphery is encapsulated in a polymer (keeping the level not higher than the lens 3) and polymerized, and then the intermediate polymer layer forming the gap 7 is applied. The gap 7 is required to ensure the display 2 resides in the focal plane of the converging GRIN lens 3. Then, in the center of the optical axis 5, the display 2 is installed, and, in the periphery, all the required electronics are installed (power and display control conductors, etc.). After which, the periphery is once again encapsulated in a polymer and polymerized to fix the display 2, and after that a finishing layer of polymer (farthermost from the cornea 6) is applied and then polymerized. Thereby, a distance is formed between the display 2 and the converging GRIN lens 3, i.e. the gap 7 filled with a layer of polymer transparent in the visible range of the spectrum (n=1.2-1.4), which has an adverse effect for the thickness of the whole optical system (it becomes thicker), but simplifies its adjustment by varying the thickness of said polymer layer.

FIG. 7 shows an embodiment of the contact lens 1 with a projector based on a 0.15-0.24 P long GRIN lens having the air gap 7 between the display 2 and the converging GRIN lens 3. The air gap 7 (refractive index n=1) is formed owing to the presence of the closed hollow rectangular or cylindrical chamber 8 made of plastic, polymer, glass or other material transparent in the visible range of the spectrum, on whose opposite parallel walls the display 2 and the converging GRIN lens 3 are mounted. Alternatively, the space of the chamber 8 can be evacuated, filled with an inert or other gas or liquid.

This whole structure can be incorporated into the contact lens 1 using the following method: on the primary layer of polymer (the closest to the cornea 6) along the optical axis 5, the chamber 8 is installed together with the display 2 and the converging GRIN lens 3, on the periphery, all the required electronics are installed (inductance coil, rechargeable battery, power and display control conductors, etc.), the periphery is encapsulated in a polymer and polymerized to fix the projection system chamber 8 with the gap 7, and then a finishing layer of polymer (farthermost from the cornea 8) is applied.

As related to geometrical dimensions, in order that the diverging rays forming the image from the display 2 completely collimated and hit the user's crystalline lens 9 as a plane-parallel beam or a beam with a small divergence (to ensure it can be focused on the retina 10), the diameter D of the converging GRIN lens 3 must be slightly larger than the maximum dimension d of the display [FIG. 5]. Otherwise, the rim rays will not be able to sufficiently diffract inside the lens 3, will hit the lens cylindrical surface and pass through it and out causing undesirable optical losses. The most preferable ratio of said dimensions is: 1.2≤D/d≤4, more precisely: 1.4≤D/d≤1.7. Herewith, the longitudinal dimension (thickness) L of the converging GRIN lens 3 along the optical axis 5 correlates with said diameter D as 0.7≤D/L≤1.7, more precisely: 1.4≤D/L 1.6. With such geometry, it is possible to provide optimal dimensions of the projection (collimating) optical system so that it can be incorporated into the contact lens 1.

The disclosed device operates as follows.

The light (image) from the display 2 hits the front surface of the converging GRIN lens 3, refracts in accordance with the parabolic law of refractive index change, and leaves the output surface located opposite the lens as a collimated or slightly diverging beam (the full angle of divergence is up to 2 degrees). The produced collimated (quasi-collimated) image of the display 2 hits the crystalline lens 9 being in a relaxed state, and is focused by the crystalline lens on the retina 10. Thereby, a sharp and clear image of the display 2 is formed, having the field of view apparent size in range from 1 to 20 degrees and visible by the eye 4 at infinity.

Alternatively, the converging GRIN lens 3 does not collimate the image from the display 2 completely, but only reduces its divergence to approximately 10 degrees (the full angle of divergence). In this case, for the image coming from the display 2 to be sharp and clear on the retina 10, the crystalline lens 9 is tensed by the ciliary muscle, and the eye 4 accommodates on the ‘virtual’ image of the display 2. Thus, the eye 4 sees the virtual image of the display 2 not at infinity, but at a certain finite distance (not closer than 80 mm from the cornea 8—the closest point at which the eye 4 can focus).

When the display 2 does not occupy the whole field of view, the side radiation, coming on the periphery of the converging GRIN lens 3 from real distant objects, as well focuses on the retina 10, creating the effect of augmented reality.

The disclosed structure makes it possible to significantly enhance compactness (i.e. reduce the overall dimensions) of the imaging system (smaller than that of the prior art), to simplify the imaging system, eliminates spherical aberrations owing to the use of the gradient lens, does not interfere with the external view owing to micro-dimensions, while making it possible to form a distinguishable and clear image on the user's eye retina.

The examples below are given to illustrate, but in no way to limit, the disclosed method.

### EXAMPLES

### Example 1

Inside a contact lens, a round 100 μm diameter LED display, having the pixel size of up to 1 μm each, is located directly on the converging GRIN lens with the light diameter (aperture) D=300 μm and the thickness L=200 μm. For this embodiment: d=100 μm, D/d=3, D/L=1.5. The converging GRIN lens is composed of the polymer layers with different concentrations of highly refractive nanoparticles and has a parabolic distribution of the refractive index along the radius; the lens optical parameters are: g=7.85 mm⁻¹, n₀=3.5, n_{R}=1.08 (R=150 μm), Δn=2.42. The produced contact lens makes it possible to form on the retina a clear focused image from the display screen.

### Example 2

Inside a contact lens, a square 70×70 μm LED display, having the pixel size of up to 1 μm each, is located directly on the converging GRIN lens with the light diameter (aperture) D=300 μm and the thickness L=400 μm. For this embodiment: d=100 μm, D/d=3, D/L=0.75. The converging GRIN lens is composed of the polymer layers with different concentrations of highly refractive nanoparticles and has a parabolic distribution of the refractive index along the radius; the lens optical parameters are: g=3.93 mm⁻¹, n₀=1.8, n_{R}=1.49 (R=150 μm), Δn=0.31. The produced contact lens makes it possible to form on the retina a clear focused image from the display screen.

### Example 3

Inside a contact lens, a square 500×500 μm (with diagonal of 700 μm) or a round 700 μm diameter LED display, having the pixel size of up to 1 μm each, is located directly on the converging GRIN lens with the light diameter (aperture) D=1.2 mm and the thickness L=1.6 mm. For this embodiment: d=700 μm, D/d=1.7, D/L=0.75. The converging GRIN lens is composed of the polymer layers with different concentrations of highly refractive nanoparticles and has a parabolic distribution of the refractive index along the radius; the lens optical parameters are: g=0.98 mm⁻¹, n₀=1.8, n_{R}=1.55 (R=600 μm), Δn=0.25. The produced contact lens makes it possible to form on the retina a clear focused image from the display screen.

### Example 4

Inside a contact lens, a round 100 μm diameter LED display, having the pixel size of up to 1 μm each, is placed with an in-between 280 μm thick layer of PMMA polymer (refractive index at the 588 nm wavelength is n_{d}=1.49) on the converging GRIN lens with the light diameter (aperture) D=400 μm and the thickness L=240 μm. For this embodiment: d=100 μm, D/d=4, D/L=1.67. The converging GRIN lens is composed of the polymer layers with different concentrations of highly refractive nanoparticles and has a parabolic distribution of the refractive index along the radius; the lens optical parameters are: g=3.93 mm⁻¹, n₀=1.8, n_{R}=1.24 (R=200 μm), Δn=0.55. The produced contact lens makes it possible to form on the retina a clear focused image from the display screen.

### Example 5

Inside a contact lens, an air-filled 150 μm long cylindrical chamber is placed along the optical axis. Attached on the opposite walls of the chamber are a converging GRIN lens having the light diameter (aperture) D=400 μm and the thickness L=240 μm and a 100 μm diameter LED display having the pixel size of up to 1 μm each and located in the lens focus. For this embodiment: d=100 μm, D/d=4, D/L=1.67. The converging GRIN lens is composed of the polymer layers with different concentrations of highly refractive nanoparticles and has a parabolic distribution of the refractive index along the radius; the lens optical parameters are: g=3.93 mm⁻¹, n₀=1.8, n_{R}=1.24 (R=200 μm), Δn=0.55. The produced contact lens makes it possible to form on the retina a clear focused image from the display screen.

1. A contact lens comprising:
a flat display with a maximum transverse dimension d, wherein a screen of the flat display is located on an axis of symmetry of the contact lens and directed towards an eye of a user,
a power and control unit, and
a collimating optical system located between the flat display and the eye of the user,
wherein the collimating optical system is implemented as a single converging lens having a diameter D and a radial refractive index gradient,
wherein an optical axis of the converging lens coincides with the axis of symmetry of the contact lens, and
wherein a ratio of the converging lens diameter D to the maximum transverse dimension of the flat display d is from 1.2 to 4.

2. The contact lens according to claim 1, wherein a refractive index difference Δn on the optical axis of the converging lens and in the peripheral part of the converging lens is at least 0.2.

3. (canceled)

4. The contact lens according to claim 3, wherein the flat display and the converging lens are made so the ratio of the converging lens diameter D to the maximum transverse dimension of the flat display d is from 1.4 to 1.7.

5. The contact lens according to claim 1, wherein the converging lens is made so that a ratio of the converging lens diameter D to a longitudinal dimension L of the converging lens along the optical axis of the converging lens is from 0.7 to 1.7.

6. The contact lens according to claim 5, wherein the ratio of the converging lens diameter D to the longitudinal dimension L of the converging lens along the optical axis of the converging lens is from 1.4 to 1.6.

7. The contact lens according to claim 1, wherein the converging lens is a cylindrical GRIN (gradient refractive index) lens having a parabolic radial distribution of the refractive index.

8. The contact lens according to claim 1, a visible angular dimension of the flat display does not exceed 50% of the field of view.

9. The contact lens according to claim 1, wherein the flat display is attached directly on a front surface of the converging lens.

10. The contact lens according to claim 1, wherein a layer of material transparent in the visible range of the spectrum is located between the front surface of the converging lens and the flat display.

11. The contact lens according to claim 1, wherein the contact lens is provided with a hollow chamber having opposite walls, and wherein the converging lens and the flat display are attached on the opposite walls with a gap between the converging lens and the flat display.

12. The contact lens according to claim 1, wherein the flat display is a light emitting diode based display.
